(19) United States
(12) Patent Application Publication
(10) Pub. No.: US 2024/0410479 A1
(43) Pub. Date: Dec. 12, 2024

(54) Self-Closing Device

(71) Applicant: Jordan Travis Ortiz, Azle, TX (US)

(72) Inventor: Jordan Travis Ortiz, Azle, TX (US)

(21) Appl. No.: 18/206,086

(22) Filed: Jun. 6, 2023

(51) Int. Cl. F16K 15/04; F16K 24/04; F16K 31/08

(52) U.S. Cl. CPC F16K 15/048; F16K 24/046; F16K 31/084

(57) ABSTRACT

The present invention relates to a self-closing device to control the entry and exit of odors, vapors, fluids, and creatures for ports, portals, and passageways including plumbing or bungholes. A self-closing device includes housing with a hollow core and a sealing piece.

### BACKGROUND OF THE INVENTION

### Field of the Disclosure

The present invention relates to a self-closing device for use in ports, portals, and passageways including indoor and outdoor fixtures, drains, plumbing, pipes, ad hoc systems, apertures, and bungholes to control the entry and exit of odor, vapor, fluid, and creatures.

### Related Art

It is common for ports, portals, and passageways including indoor and outdoor fixtures, drains, plumbing, pipes, ad hoc systems, apertures, and bungholes to allow the entry and exit of odors, vapor, fluid, and creatures. This becomes an issue when the entry and exit is undesired, as in a cold draft, malodor, evaporate, drain flies, among other things. These issues are presently addressed by applied means such as a stopper, plug, control valves such as pinch valves, among other means; or passive means such as a check valve, P-trap, or those shown in KR20130035462A, KR101162288B1, KR101101235B1. The applied means rely upon user input, either manual, pneumatic, electric or otherwise, and subject the user to inconvenience from manual activation or proximity to an energy source and predicate the efficacy of the applied means to continuous input either by schedule or uninterrupted energy source. The passive means prevent unidirectional backflow, subjecting the user to inconvenience when multiple materials of different desirability are in transit or passive control of bidirectional transit is desired. Accordingly, a self-closing device that avoids and addresses these and other problems is desirable.

### BRIEF SUMMARY OF THE INVENTION

The present invention has been made to address the above problems. It is, therefore, an object of the present invention to provide a self-closing device that passively controls bidirectional transit without an external power source.

A self-closing device in accordance with an embodiment of the present application includes a housing, a hollow core within the housing, an upper aperture on the housing, a lower aperture on the housing, and a sealing piece in the hollow core of the housing. The sealing piece moves within the hollow core of the housing but is of larger size than the upper and lower apertures, which contain the sealing piece in the hollow core of the housing.

The following discloses additional and more detailed descriptions of the present invention.

### BRIEF DESCRIPTION OF THE SEVERAL VIEWS OF THE DRAWING

FIG. 1 illustrates a profile view of a self-closing device in accordance with an embodiment of the present disclosure.

FIG. 2 illustrates a horizontal cross-sectional view of a self-closing device in accordance with an embodiment of the present disclosure.

FIG. 3 illustrates a horizontal cross-sectional view of a self-closing device in accordance with an embodiment of the present disclosure.

FIG. 3A illustrates top or transverse view of the middle of FIG. 3.

FIG. 3B illustrates a top view of the sealing piece illustrated in FIG. 3.

FIG. 4 illustrates a horizontal cross-sectional view of a self-closing device in accordance with an embodiment of the present disclosure.

FIG. 5 illustrates a horizontal cross-sectional view of a self-closing device in accordance with an embodiment of the present disclosure.

FIG. 6 illustrates a profile view of self-closing device in a cross-sectioned port.

### DETAILED DESCRIPTION OF THE INVENTION

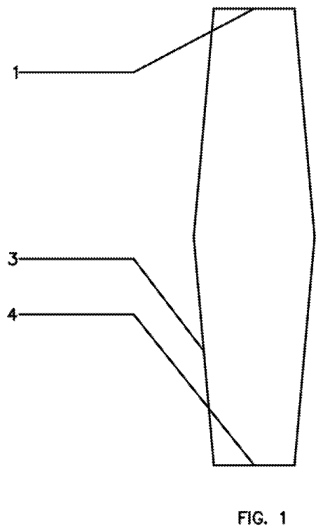

A profile view of the modular self-closing device in accordance with an embodiment of the present disclosure is illustrated in FIGS. 1, 2, 3, 4, 5, and 6.

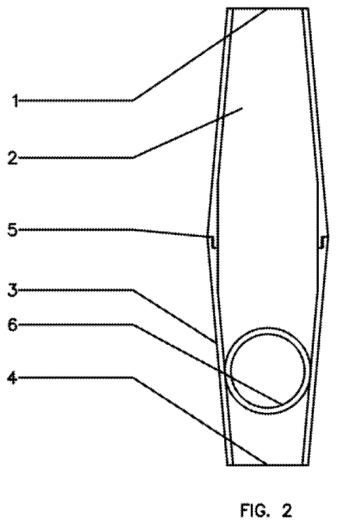

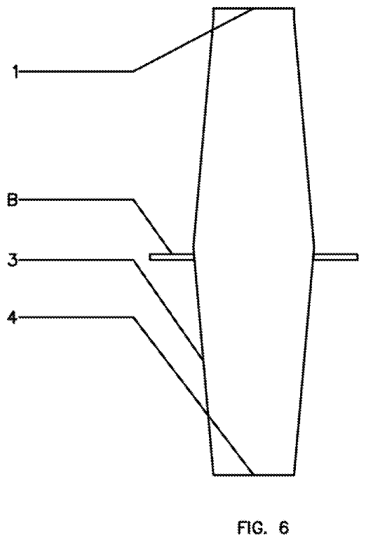

As shown in FIG. 1 and FIG. 2, the hollow core 2 is within the housing 3 which is preferably but not limited to the shape of a bicone comprised of two truncated cones, with the upper aperture 1 and the lower aperture 4 being on the terminal ends of the housing 3 and in communication with the hollow core 2 of the housing 3. Within the hollow core 2 resides the sealing piece 6 which moves to either end of the housing 3 depending on the pressure applied to the sealing piece 6 which is preferably buoyant. When applied to a port or drain B as shown in FIG. 6 the sealing piece would rest on the lower aperture 4 due to gravity, and when fluid is applied through the upper aperture 1, the scaling piece 6 would float. Should the drain overflow, or pressure from the lower aperture 4 manifest, the scaling piece 6 would be pressed against the upper aperture 1 preventing exit. This is possible, due the size of the upper aperture 1 and the lower aperture 4 which preferably are but not limited to 37.86% to 47.88% of the diameter of the sealing piece 6. In some embodiments of the present invention the hollow core 2 features a taper towards the upper aperture 1 and the lower aperture 4 with a taper angle between 2.85° and 6.76°, but ideally between 3.80° and 5.41°. The length of the tapers will vary by need but should consider projected flow volume and size of the sealing piece 6.

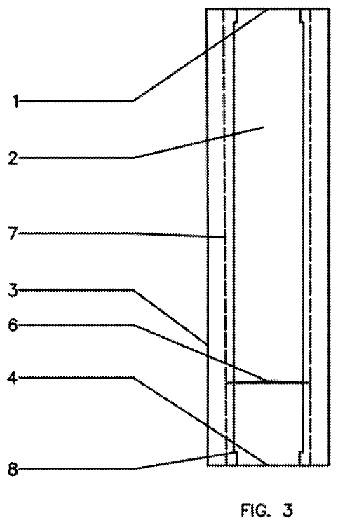

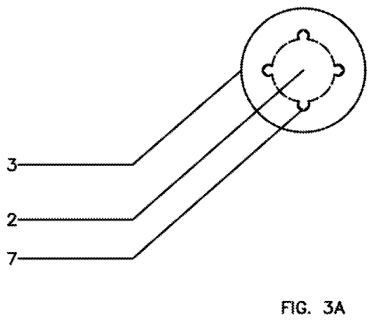

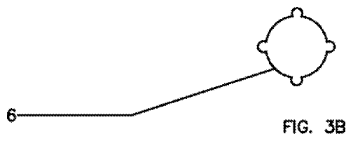

FIG. 3 shows another embodiment of the present invention with the upper aperture 1 and the lower aperture 4 achieving a smaller diameter than the sealing piece 6 with a lip 8.FIGS. 3, and 3A also show a groove 7 within the hollow core 2 to guide the sealing piece 6 as shown in FIG. 3B. In this embodiment, the sealing piece 6 does not fully fill the grooves 7, allowing fluid, vapor past until contacting the lip 8 of the upper aperture 1 or the lower aperture 4.

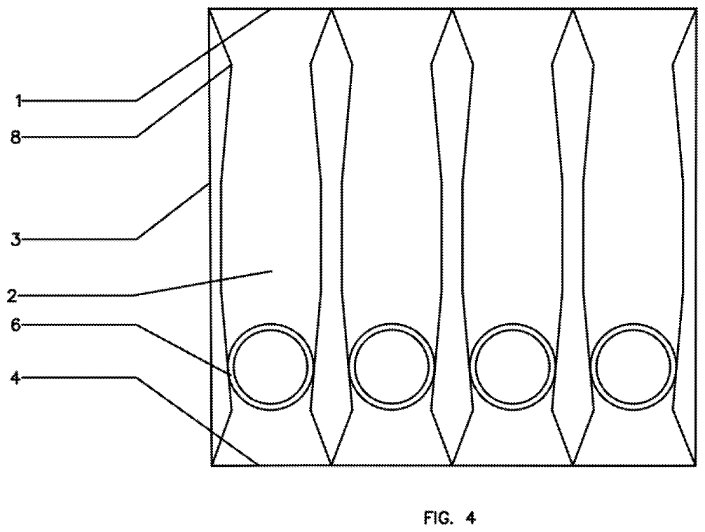

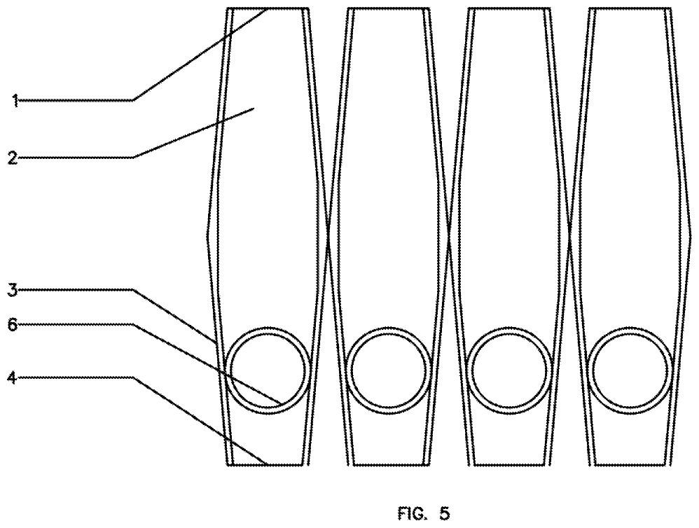

FIG. 4 and FIG. 5 show another embodiment of the present invention where multiple hollow cores 2, scaling pieces 6, upper apertures 1, and lower apertures 4 are used to control a space of different dimensions or purposes.

The self-closing device is preferably openable at a connection point 5 such as threading or other attachment means as shown in FIG. 2. This allows the cleaning of the housing 3 from debris, clogs, etc. and replacement of the sealing piece 6 which can be resized or remade as needed. If the housing 3 of the self-closing device is a unibody, a port along the side of the housing 3 and preferably of elastomeric material and diameter greater than the diameter of the sealing piece 6 can be used to remove, or replace the sealing piece 6 from within the housing 3.

The construction of the self-closing device 18 can vary by element and by need. The housing 3 can be constructed of brass, bronze, silver, plastic, silicone, wood, etc. but is preferably rigid. The sealing piece 6 can be hollow or solid and can be constructed of brass, bronze, steel, silver, plastic, wood, etc.; however, it is preferably of weaker construction (thinner if same material) than the housing 3. The construction material should be chosen with respect to application, where the resistance to force can be less than that of the pipes, etc. in the system to allow the sealing piece 6 to buckle under high pressure. The resistance should be sufficient for the media passed through the self closing device.

The housing 3 should be sized for purpose and in embodiments demonstrating a tapered housing 3, the self-closing device can be slid into the port, bunghole, etc. B of different sizes as demonstrated in FIG. 6. This use allows for convenient use in outdoor locations, such as rain collection barrels. Meshes, or screens, strainers, funnels, canopies, or other attachments could be used in conjunction with the self-closing device, or could comprise the self-closing device as well. The self-closing device could also be used in conjunction with plumbing, pipes, port, or other systems where a media, such as liquid, drafts, odors, gas, and solids are desired to be measured or controlled, or could comprise the self-closing device as well. In another embodiment of the invention, the terminal ends of the housing 3 can comprise of threading or other attachment means, for use of the present invention with other systems.

I claim:

1. A self-closing device comprising of:
A housing, a hollow core, an upper aperture, a lower aperture, a sealing piece;
The hollow core being surrounded by the housing;
The upper aperture and the lower aperture traversing the housing;
The upper aperture and the lower aperture being in communication with the hollow core;
The sealing piece being located within the housing;
The sealing piece being moveable within the hollow core;
The upper aperture and the lower aperture having a smaller diameter than the diameter of the sealing piece;

2. The self-closing device of claim 1 wherein the upper aperture, the lower aperture, the hollow core, the housing, and the sealing piece comprise a plurality of upper apertures, lower apertures, hollow cores, housings, and sealing pieces.

3. The self-closing device of claim 1 when the housing is incorporated with plumbing pipes and plumbing fixtures, ports, portals, and passageways;

4. The self-closing device of claim 1 having a hollow core wherein a diameter parallel to the upper aperture and the lower aperture is reduced along the axis traversing through the upper aperture and the lower aperture;

5. The self-closing device of claim 1 wherein the upper aperture and the lower aperture, or the housing contingent to these, features a retaining means;

6. The self-closing device of claim 1 wherein the upper aperture and the lower aperture feature a straining element;

7. The self-closing device of claim 1 wherein the housing is separable into at least two parts at a connection point;

8. A self-closing device comprising of:
A housing, a hollow core, an upper aperture, a lower aperture, a sealing piece;
The housing being separable into at least two parts by a connection point;
The housing being a hollow truncated bicone;
The housing being tapered between 2.85° and 6.76°;
The hollow core being surrounded by the housing;
The hollow core having a diameter parallel to the upper aperture and the lower aperture being reduced along the axis traversing the upper aperture and the lower aperture;
The upper aperture and the lower aperture traversing the housing;
The upper aperture and the lower aperture being in communication with the hollow core;
The upper aperture and the lower aperture being oppositely located to each other;
the upper aperture and the lower aperture are between 37% and 47% of the diameter of the sealing piece;
The sealing piece being located within the housing;
The sealing piece being moveable within the hollow core;
The upper aperture and the lower aperture having a smaller diameter than the diameter of the sealing piece;
The sealing piece being of smaller diameter than the largest diameter of the hollow core.

9. The self-closing device of claim 8 wherein the upper aperture, the lower aperture, the housing, and the sealing piece comprise a plurality of upper apertures, lower apertures, housings, and sealing pieces.

10. The self-closing device of claim 8 wherein the upper aperture and the lower aperture are between 37% and 47% of the diameter of the sealing piece;

11. The self-closing device of claim 8 wherein the sealing piece comprises a spherical shape.

12. The self-closing device of claim 8 wherein the sealing piece is buoyant;

13. The self-closing device of claim 8 when incorporated with plumbing pipes and plumbing fixtures;

14. The self-closing device of claim 8 when incorporated with ports, portals, and passageways;

15. The self-closing device of claim 8 wherein the upper aperture and the lower aperture, or the housing contingent to these, features a retaining means;

16. The self-closing device of claim 8 wherein the upper aperture and the lower aperture feature a straining element;

17. The self-closing device of claim 8 wherein the reduction in diameter involves at least 1 perimetric steps;

18. The self-closing device of claim 8 wherein the sealing piece is magnetic;

19. The self-closing device of claim 18 wherein the upper aperture and the lower aperture contain at least an annulus of magnetic material.

20. The self-closing device of claim 18 wherein the housing contains magnetic material in the portion of the housing with a diameter less than the diameter of the sealing piece;

21. The self-closing device of claim 8 wherein the housing features a removable port of diameter greater than the sealing piece's diameter;

22. The self-closing device of claim 8 wherein the housing features a common means of connection to other devices.
